(19) United States
(12) Patent Application Publication
(10) Pub. No.: US 2005/0152003 A1
(43) Pub. Date: Jul. 14, 2005

(54) Image processing apparatus and data editing method

(76) Inventor: Nobuyuki Yokoyama, Tokyo (JP)

Correspondence Address: RABIN & Berdo, PC, 1101 14TH STREET, NW, SUITE 500, WASHINGTON, DC, 20005, US

(21) Appl. No.: 11/028,572

(22) Filed: Jan. 5, 2005

(30) Foreign Application Priority Data
Jan. 8, 2004 (JP) JP2004-002831

(51) Int. Cl. G06K 15/02; G06F 3/12

(52) U.S. Cl. 358/1.18; 358/452

(57) ABSTRACT

What is disclosed is: an image processing apparatus comprising: a memory section for containing plural printing data made by plural applications, an input section for inputting information of laying out said printing data, an analyzing section for analyzing said information of laying out said printing data, and a laying out control section for reading out said printing data from said memory section and for laying out said printing data on a recording medium.

### BACKGROUND OF THE INVENTION

1. Field of the Invention

The present invention relates to an image processing apparatus and a data editing method.

2. Description of Related Art

In a conventional art, an image processing apparatus including a printer, a copy machine, a facsimile etc. and a data editing method which is used in such apparatus, for example, a printer and a printer driver as a host device of the printer; have: a function of printing plural pages on a face of a sheet, that is, a function of multi-page printing; a function of printing two successive pages on both faces of a sheet, that is, a function of double-face printing etc.

And, in the function of multi-page printing; for example, two-page printing, that is, printing two pages on a face of a sheet; when a print data is sent from a host device, a control section of a printer decreases the size of each letter in the print data to a half size, and lays two successive pages in a range of a sheet, so as to print.

Moreover, in the function of double-face printing, a control section of a printer prints a first page to a first face of a page, and a second page to a second face of the same page (c.f. JP2000-289304).

However, in the conventional printer, in case that an odd number of pages are printed, an empty face is formed at the last sheet when the last page is printed. Therefore, a sheet where the last page is printed, is not able to use the other face.

Especially, in case that an odd number of pages are printed by many different applications, each empty face is formed at the last sheet when each last page is printed. Therefore, many sheets where each of the last pages are printed, are used being the other face of them left unused.

The present invention is aimed at providing an image processing apparatus and a data editing method which are able to solve the problem of the conventional printer or editing method, so as to make use of the other face of the last sheet.

### SUMMARY OF THE INVENTION

According to one aspect of the present invention, there is provided an image processing apparatus comprising: a memory section for containing plural printing data made by plural applications, an input section for inputting information of laying out said printing data, an analyzing section for analyzing said information of laying out said printing data, and a laying out control section for reading out said printing data from said memory section and for laying out said printing data on a recording medium.

According to another aspect of the present invention, there is provided a data editing method comprising a steps of: containing plural printing data made by plural applications in a memory section, inputting information of laying out said printing data with an input section, analyzing said information of laying out said printing data with an analyzing section, reading out said printing data from said memory section, and laying out said printing data on a recording medium with a laying out control section.

### BRIEF DESCRIPTION OF THE DRAWINGS

FIG. 1 is a block diagram showing a printer driver of Embodiment 1;

FIG. 2 is a block diagram showing a printing system of Embodiment 1;

FIG. 3 is a diagram showing a presentation screen for laying out printing data of Embodiment 1;

FIG. 4 is a diagram showing a presentation screen for changing lay out of printing data of Embodiment 1;

FIG. 5A is a diagram showing a concept of laying out two pages of printing data of Embodiment 1;

FIG. 5B is a diagram showing another concept of laying out two pages of printing data of Embodiment 1;

FIG. 6 is a flow chart showing an operation of printing process of Embodiment 1;

FIG. 7 is a flow chart showing a subroutine of laying out process of Embodiment 1;

FIG. 8 is a diagram showing a presentation screen for laying out printing data of Embodiment 2;

FIG. 9A is a diagram showing a concept of laying out printing data of Embodiment 2;

FIG. 9B is a diagram showing another concept of laying out printing data of Embodiment 2;

FIG. 10 is a flow chart showing a subroutine of laying out process of Embodiment 2;

FIG. 11 is a block diagram showing a printer driver of Embodiment 3;

FIG. 12 is a diagram showing a presentation screen for laying out printing data of Embodiment 3;

FIG. 13 is a diagram showing a presentation screen for laying out printing data when an order of pages are changed of Embodiment 1;

FIG. 14 is a diagram showing a presentation screen for laying out printing data of Embodiment 3;

FIG. 15 is a diagram showing a concept of laying out printing data of Embodiment 3.

### DESCRIPTION OF THE PREFERRED EMBODIMENTS

Hereinafter, Embodiments of the present invention will be described in detail referring to the drawings. In this case, a printer driver among image processing apparatuses, will be described. Incidentally, a page printer is used as the printer described.

### Embodiment 1

Configuration

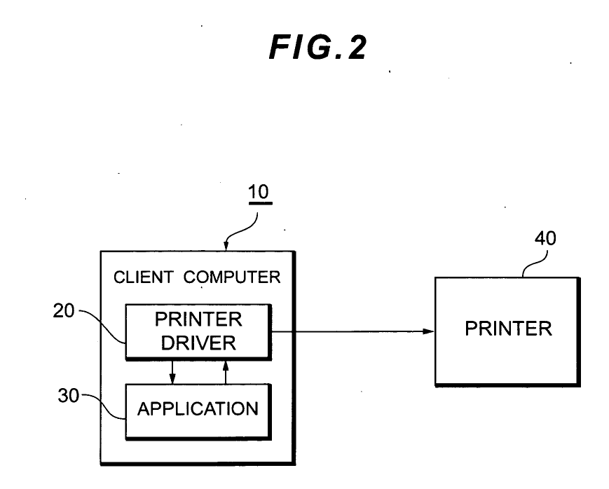

FIG. 2 is a block diagram showing a printing system of Embodiment 1.

In FIG. 2, a client computer 10 is a computer operating as a host device of a printer 40, in Embodiment 1. The client computer 10 and the printer 40 comprise a printing system as an image forming system. Incidentally, the client computer is provided with a keyboard as an inputting section not shown in the drawing and a display as a presenting section not shown in the drawing.

The client computer 10 comprises a printer driver 20 as a print processing unit and an application 30 which is unspecified. Here, plural applications with different functions are able to operate simultaneously.

Subsequently, said printer driver 20 will be described.

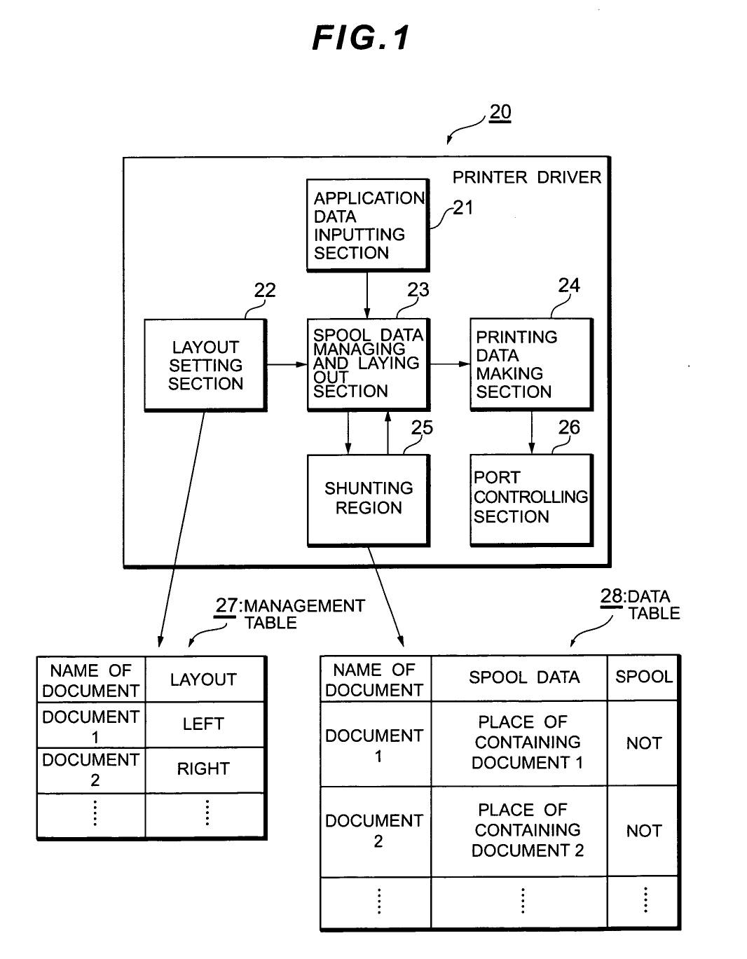

FIG. 1 is a block diagram showing a printer driver of Embodiment 1.

As shown in FIG. 1, the printer driver 20 is provided with an application data inputting section 21, a layout setting section 22 as an input section for inputting information of laying out printing data, and as an analyzing section for analyzing said information of laying out the printing data, a spool data managing and laying out section 23 as a laying out control section for reading out said printing data from said memory section and for laying out said printing data on a recording medium, a printing data making section 24 as a printing data making and processing section, and a shunting region 25 as a memory section, and a port controlling section 26 as a printing data output processing section.

The layout setting section 22 performs a process of setting lay out for printing. It makes a management table 27 for information of setting, refers to information of layout, and analyzes information of layout. The management table 27 for information of setting, contains names of documents, positions of layout of, for example, documents 1, 2; that is, for example, right or left. Each of the names and positions of layout are contained corresponding to each other. Moreover, a data table 28 in the shunting region 25, is a table concerning to spool data contained in the shunting region 25. The data table 28 contains each name of documents, each place where each of spool data are contained, and each information (contained or not contained) indicating whether the spool data is contained in the shunting region 25 or not.

Subsequently, an operation of the printing system having the structure mentioned above will be described.

First of all, an ordinary printing operation is described. In case of an ordinary printing operation, in an application 30, an application data is made so as to put out a data for printing This data is used for printing a document including a content of printing. The application data inputting section 21 obtains the application data from the application 30.

And, the application data inputting section 21 sends the application data to the spool data managing and laying out section 23. The spool data managing and laying out section 23 manages and lays out spool data. The application data is contained in the shunting region 25 as a spool data. And, the spool data managing and laying out section 23 judges whether the document is an ordinary print job or not. In case that the document is an ordinary print job, the spool data managing and laying out section 23 reads out the spool data from the shunting region 25, so as to send to the printing data making section 24. The printing data making section 24 makes a printing data, that is, a print command stream such as PDL etc. And, the printer 40 recognizes the print command stream. Succeedingly, the port controlling section 26 puts out the print command stream, that is, a print data to the printer 40.

Subsequently, a printing operation using a function of multi-page printing is described. That is, a layout printing, using a function of printing plural pages on a face of a sheet. For example, two-page-layout printing, that is, a printing operation using a function of printing two pages on a face of a same sheet. Here, each page of two pages are made in different applications.

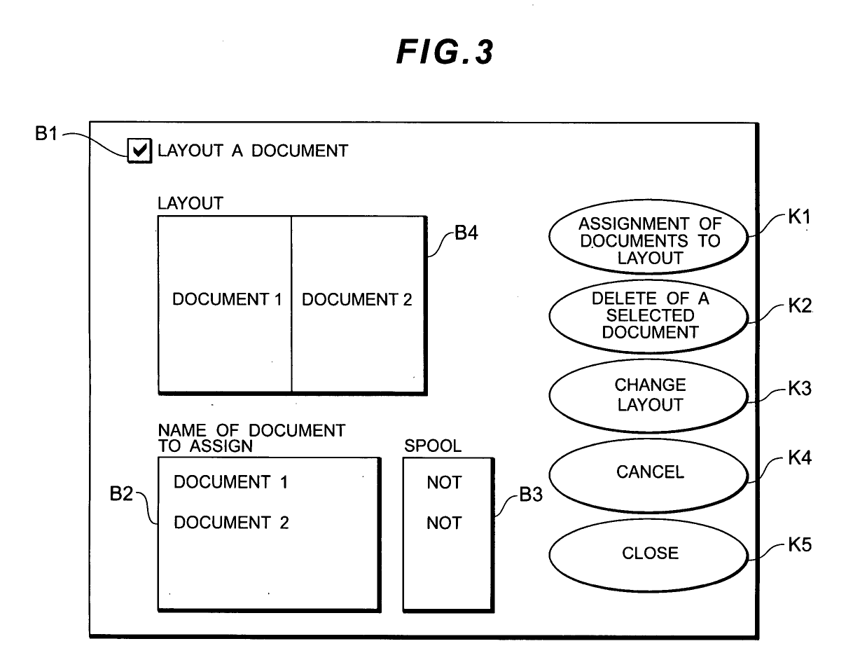

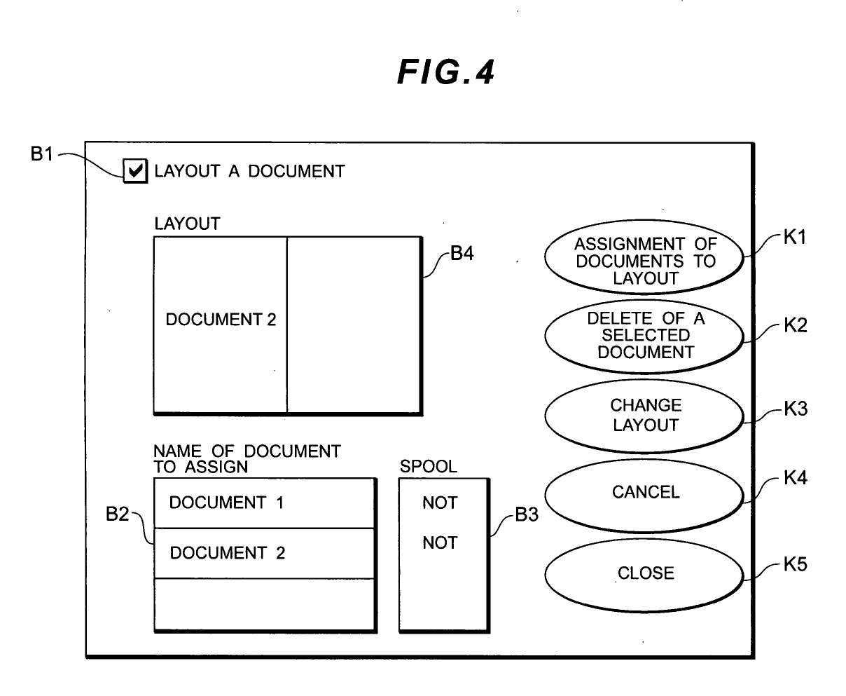

FIG. 3 is a diagram showing a presentation screen for laying out printing data of Embodiment 1. FIG. 4 is a diagram showing a presentation screen for changing layout of printing data of Embodiment 1.

In Embodiment 1, an application 30 operates in order to edit a document file of a document 1. Incidentally, a layout printing setting screen like shown in FIG. 3, can be selected from a property screen of the printer driver 20, which is presented when a menu of “printing” is assigned from the application 30.

And, when an operator operates a keyboard and checks a check box B1 to lay out a document on the layout printing setting screen shown in FIG. 3, a function of multi-page printing is made effective. Then, in a list box B2 of “document names to lay out”, “document 1” is registered automatically.

Subsequently, when the operator clicks a button K1 “assignment of documents to lay out”, a selection screen of documents not shown in the drawings, is presented. Then, the other document to lay out, for example, in Embodiment 1, a document 2 is selected and assigned. As a result, documents laid out, that is, in Embodiment 1, documents 1 and 2 laid out, are presented in a box B4 of “layout”. With this, the layout setting section 22 inputs information of layout to the management table 27 (FIG. 2). Incidentally, a method of assigning, can be performed with using a selection screen which is proper to an operation system. Then, documents to select can be assigned on a layout printing setting screen, by using a method of “drag and drop”.

And, the assigned documents are added to the list box B2. Incidentally, for example, in case that a wrong document is assigned by mistake, a name of the document to be deleted, is selected, to be presented in a highlight on the screen. Then, a button K2 of “delete of a selected document” is clicked. Thereby, the document presented in a highlight on the screen, is deleted from the list box B2.

Moreover, in case that the assigned document is spooled, “spooled” is presented in the list box B3 of “spool” neighboring to the list box B2. In case that the assigned document is not spooled, “not spooled” is presented in the list box B3. Incidentally, in case that a printing of the assigned document is not performed; whether all the presentations in the list box B3 are becoming “spooled” or not, is judged. Thereby, whether any documents not spooled exist or not, is confirmed.

And, in case that an operator wants to change the layout laid on the layout printing setting screen, the operator clicks a button K3 of “change layout”. Then, the layout laid in the box B4 is cleared. And, a document presented in the list box B2 can be assigned with using “drag and drop”. FIG. 4 shows an example of layout when a document 2 is assigned in the left side of the box B4.

The above series of operation steps hereto, are enough, if they are performed only once at the beginning of the overall operation. And, as for the other documents, that is, the document 2 of Embodiment 1, this setting is not necessary. Only performing operation steps for an ordinary printing, is enough. Incidentally, K4 is a button of “cancel” for cancelling an operation; and K5 is a button of “close” for ending an operation.

Subsequently, according an application data put out from the application 30 to the printer driver 20, how a printing data is made and a printing is performed, is described.

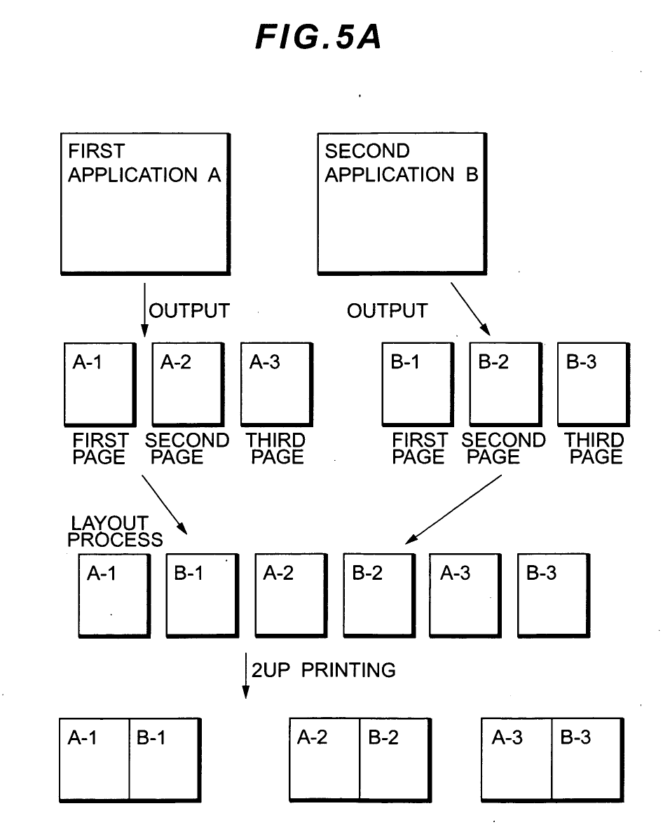

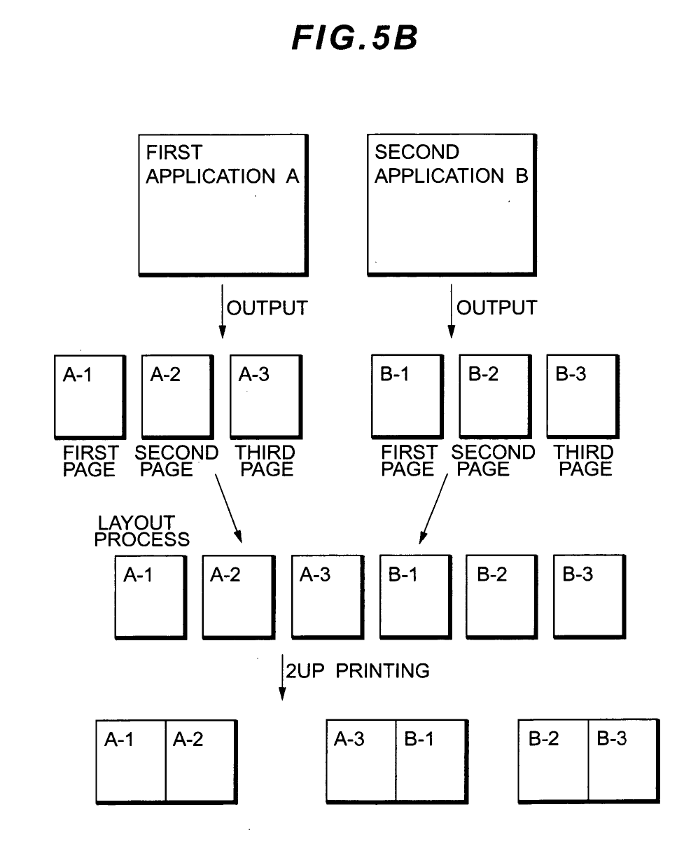

FIG. 5A is a diagram showing a concept of laying out three pages of printing data of Embodiment 1; FIG. 5B is a diagram showing another concept of laying out three pages of printing data of Embodiment 1.

In Embodiment 1, different application data of three pages are put out from a first application and a second application comprising the application 30 (FIG. 1). And, the printer driver 20 (FIG. 2) lays out each application data in a same page.

First of all, a first page of the application data put out from the first application, is named A-1; a second page is named A-2; and a third page is named A-3. On the other hand, a first page of the application data put out from the first application, is named B-1; a second page is named B-2; and a third page is named B-3.

And, a spool data managing and laying out section 23 performs a layout process. That is, according to layout information analyzed by the layout setting section 22, the spool data is laid being divided into plural regions divided from a same page. In Embodiment 1, the plural regions are two regions. Then, A-1, A-2 etc. are laid in each left region of printing pages; and B-1, B-2 etc. are laid in each right region of printing pages. Incidentally, in this case, information of printing multi-page is made from said layout information.

Succeedingly, the printing data making section 24 makes a printing data according to the spool data laid out, so as to send it to the port controlling section 26. And, through the port controlling section 26, said printing data is sent to a printer 40. Then, a two-page printing is performed in the printer 40. In this case, each print content of A-1, B-1 is printed in a first printing page, each print content of A-2, B-2 is printed in a second printing page, and each print content of A-3, B-3 is printed in a third printing page.

Subsequently, a printing process performed by said printer driver is described.

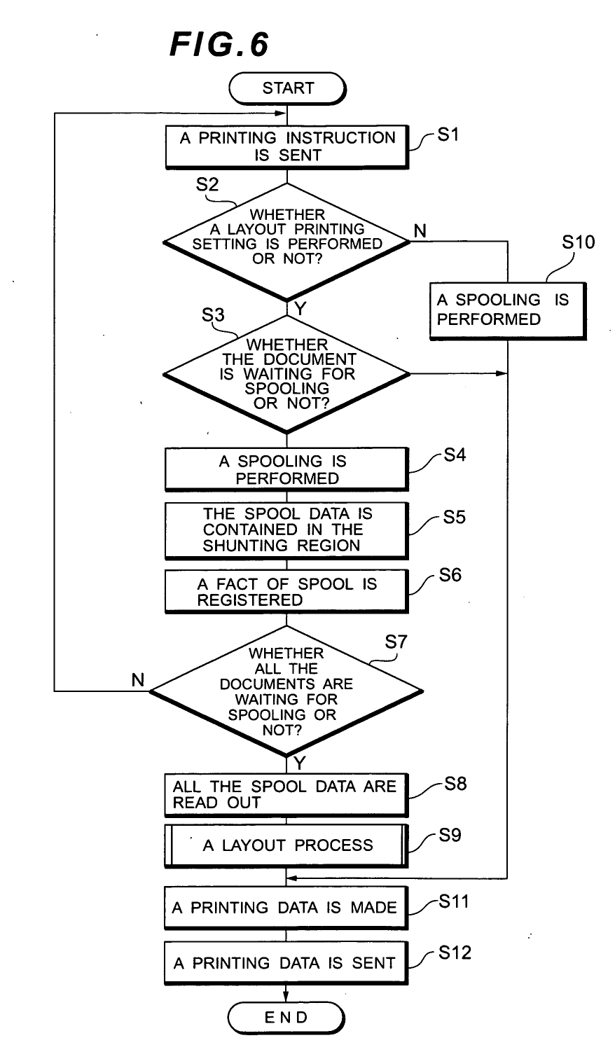

FIG. 6 is a flow chart showing an operation of printing process of Embodiment 1.

First of all, when a printing instruction is sent from the application 30 (FIG. 1), inquires of the layout setting section 22 whether a layout printing setting, that is, a setting of a layout printing is performed or not, about an application data of a document directed to be printed. The layout setting section 22 refers to the management table 27. And, it reads a layout position per each document directed to be printed. Then, it informs the spool data managing and laying out section 23 whether a layout printing setting is performed or not. In case that a layout printing setting is not performed, the spool data managing and laying out section 23 performs a spool. Thereby, the spool data is contained in the shunting region 25. After that, the spool data managing and laying out section 23 starts a process about said spool data as this data is an ordinary print job, that is, it reads the spool data from the shunting region 25 and sends it to a printing data making section 24.

And, the printing data making section 24 makes a print data according to the spool data, and the port controlling section 26 sends the print data made, to a printer 40.

On the other hand, in case that a printing setting is performed, the spool data managing and laying out section 23 refers to a data table 28. And, it judges whether the document directed to be printed, is not finished spooling, and is waiting for spooling or not.

And, in case that the document directed to be printed, is not waiting for spooling, and it is finished spooling; or in case that it is not a subject for spooling; it starts a process as an ordinary print job.

Moreover, in case that the document directed to be printed, is waiting for spooling, and it is not finished spooling; the spool data managing and laying out section 23 performs a spooling. Thereby, the spool data is contained in the shunting region 25. Then, a place where the spool data of said document, and a piece of information that said document is spooled; are contained and registered.

Subsequently, the spool data managing and laying out section 23 refers to the data table 28. Then, it judges whether spooling of all documents are finished or not. In case that documents not spooled, exist; it waits for succeeding instruction of printing to come from the application 30. Moreover, in case that spooling of all documents are finished; layout process unit not shown in the drawings of the spool data managing and laying out section 23, performs a layout process. That is, it read all the spool data from the shunting region 25. Then, it lays the spool data laid in a layout on the layout printing setting screen.

And, the printing data making section 24 makes a print data according to the spool data laid out, and the port controlling section 26 sends the print data made, to a printer 40.

Succeedingly, a description will be performed referring to a flow chart.

STEP S1 A printing instruction is sent.

STEP S2 Whether a layout printing setting is performed or not, is judged. In case that a layout printing setting is performed, the process proceeds to STEP S3. In case that a layout printing setting is not performed, the process proceeds to STEP S10.

STEP S3 Whether the document is waiting for spooling or not, is judged. In case that the document is waiting for spooling, the process proceeds to STEP S4. In case that the document is not waiting for spooling, the process proceeds to STEP S11.

STEP S4 A spooling is performed.

STEP S5 The spool data is contained in the shunting region 25.

STEP S6 A fact of spool is registered.

STEP S7 Whether all the documents are waiting for spooling or not, is judged. In case that all the document are waiting for spooling, the process proceeds to STEP S8. In case that all the document are not waiting for spooling, the process returns to STEP S1.

STEP S8 All the spool data are read out.

STEP S9 A layout process is performed.

STEP S10 A spooling is performed.

STEP S11 A printing data is made.

STEP S12 A printing data is sent, and the process ends.

Succeedingly, a subroutine of a layout process in STEP S9 of FIG. 6 will be described.

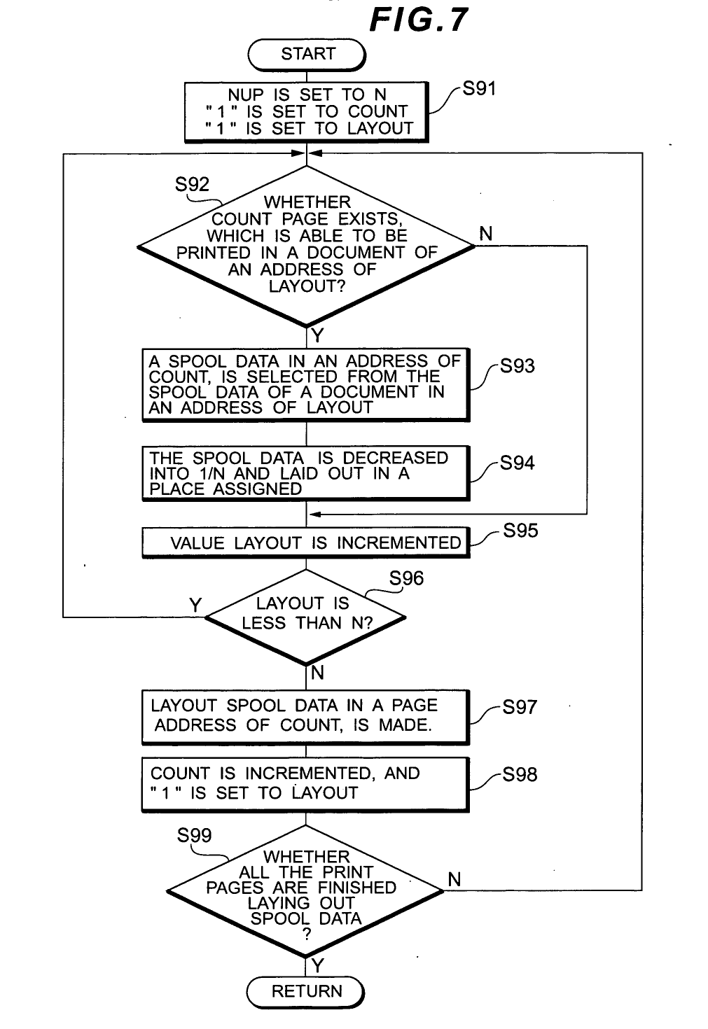

FIG. 7 is a flow chart showing a subroutine of laying out process of Embodiment 1.

In this case, the layout process unit edits a spool data read out from the shunting region 25 in a layout assigned in the layout printing setting screen as shown in FIG. 3 per each printing page.

For this purpose, Nup number (“2” in Embodiment 1) which represents a number of documents laid in a same printing page, is set to a value N. Count value which represents page address of each document, is set to “1”. Layout value which represents document address of each document, is set to “1”.

And, the layout process unit judges whether Count page exists or not, which is able to be printed in a document of an address of Layout assigned in each layout (left side). In case that Count page does not exist, the layout process unit skips the process of the layout portion. The portion skipped is not printed by the printer 40.

Moreover, in case that Count page exists, the layout process unit selects a spool data in an address of Count of the corresponding page, from the spool data of a document in an address of Layout. And, it decreases the spool data selected, into a size of print region of a layout assigned, that is, 1/N. Then, it lays out it in a place assigned by an address of Count (lay out again).

And, the layout process unit increments a value of Layout. Then, the layout process unit judges whether Count page exists or not, which is able to be printed in a document of an address of Layout assigned in another layout (right side). In case that Count page does not exist, the layout process unit skips the process of the layout portion.

Moreover, in case that Count page exists, the layout process unit selects a spool data in an address of Count of the corresponding page, from the spool data of a document in an address of Layout. And, it decreases the spool data selected, into a size of print region of a layout assigned, that is, 1/N. Then, it lays out it in a place assigned by an address of Count.

And, the layout process unit repeats these steps until the value of Layout becomes N. When the value of Layout becomes N, the layout process unit makes a spool data laid in a page address of Count. Then, it increments the value Count. And, it sets “1” to the value Layout. Then, it judges whether all the print pages are finished laying out spool data. In case that all the print pages are finished laying out spool data, the process ends.

Thus, in Embodiment 1, plural documents made independently by plural applications having different functions, are able to be printed laying in a same printing page, by assigning each name of the documents in the printer driver 20. Therefore, for example, a document made by an application of a word processor, is laid in the left side of the layout. And, a table, a graph etc. made by an application of a graphic processor, is laid in the right side of the layout. Then, such a printing is able to be performed. As a result, waste of sheets can be prevented.

If Embodiment 1 is not used; and in case that a multi-page printing of two pages, is performed by using a conventional multi-page printing function about a document of each three pages made by different applications; in a result of a printing of each document, blank of a half page of a print medium occurs. Then, one page of a print medium as whole is wasted.

Succeedingly, a description will be performed referring to a flow chart.

STEP S91 Nup number is set to value N. “1” is set to value Count and value Layout.

STEP S92 Whether Count page exists or not, which is able to be printed in a document of an address of Layout, is judged. In case that Count page exists, the process proceeds to STEP S93. In case that Count page does not exist, the process proceeds to STEP S95.

STEP S93 A spool data in an address of Count of the corresponding page, is selected from the spool data of a document in an address of Layout.

STEP S94 The spool data is decreased into 1/N. Then, it lays out it in a place assigned.

STEP S95 Value Layout is incremented.

STEP S96 Value Layout is judged whether it is less than value N or not. In case that value Layout is less than value N, the process returns to STEP S92. In case that value Layout is more than or equal to value N, the process proceeds to STEP S97.

STEP S97 Layout spool data in a page address of Count, is made.

STEP S98 Value Count is incremented, and “1” is set to value Layout.

STEP S99 Whether all the print pages are finished laying out spool data or not, is judged. In case that all the print pages are finished laying out spool data, the process returns to the main routine. Otherwise, the process proceeds to STEP S92.

In the above Embodiment, as a layout method of two documents, an example of laying out each document assigned at left or right position of recording medium, is described. However, as shown in FIG. 5B, each of pages in a first document are laid in the left and right positions of a print medium in an order. Then, a layout method of laying out each page of a second document in the left and right positions succeedingly after finishing layout of a first document in the left and right positions, can be adopted. This method can similarly prevent from wasting recording media.

### Embodiment 2

Configuration

Subsequently, Embodiment 2 of the present invention which prints plural independent documents made by plural different applications 30, in a first face and a second face, that is, each face of front and back of a sheet; is described.

In this case, a layout printing when two documents are laid out in both faces of a sheet of recording media, is described.

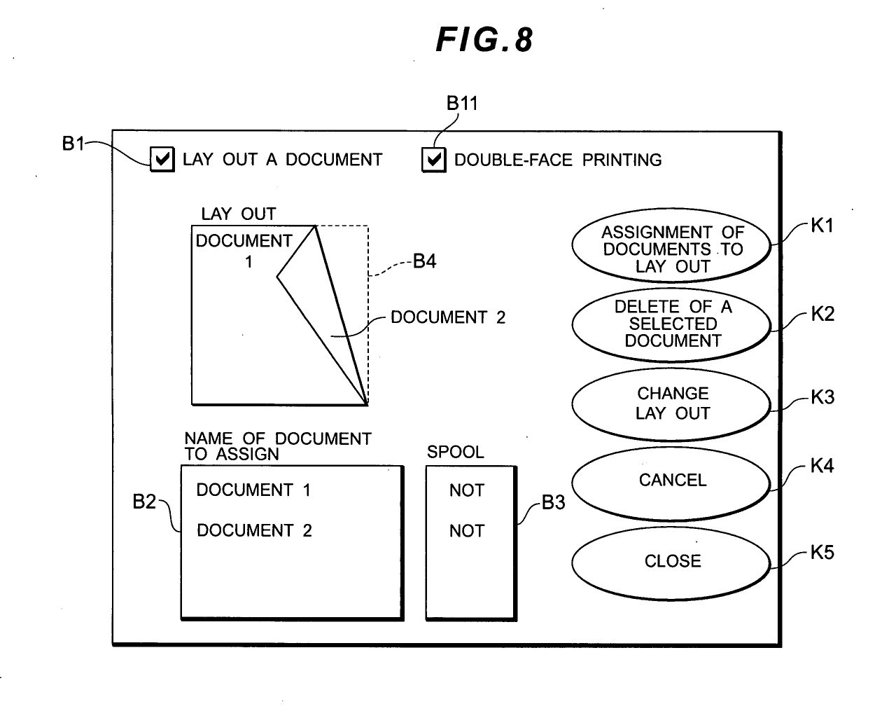

FIG. 8 is a diagram showing a presentation screen for laying out printing data of Embodiment 2.

In this case, when an operator operates a keyboard as an inputting section, and checks a check box B1 to lay out a document on the layout printing setting screen as a presenting section shown in FIG. 8, a function of multi-page printing is made effective. Moreover, when an operator operates checks a check box B11 of double-face printing, the layout printing setting screen changes to a layout of double-face printing. Then, in a list box B2 of “document names to lay out”, “document 1” is registered automatically.

Subsequently, when the operator clicks a button K1 “assignment of documents to lay out”, a selection screen of documents, is presented. Then, the other document to lay out, for example, in Embodiment 2, a document 2 is selected and assigned. As a result, documents laid out, that is, in Embodiment 2, documents 1 and 2 laid out, are presented in a box B4 of “layout”.

And, the assigned documents are added to the list box B2. Incidentally, for example, in case that a wrong document is assigned by mistake, a name of the document to be deleted, is selected, to be presented in a highlight on the screen. Then, a button K2 of “delete of a selected document” is clicked. Thereby, the document presented in a highlight on the screen, is deleted from the list box B2.

Moreover, in case that the assigned document is spooled, “spooled” is presented in the list box B3 of “spool” neighboring to the list box B2. In case that the assigned document is not spooled, “not spooled” is presented in the list box B3.

And, in case that an operator wants to change the layout laid on the layout printing setting screen, the operator clicks a button K3 of “change layout”. Then, the layout laid in the box B4 is cleared. And, a document presented in the list box B2 can be assigned with using “drag and drop”. Incidentally, in FIG. 8, K4 and K5 are buttons.

The above series of operation steps hereto, are enough, if they are performed only once at the beginning of the overall operation. And, as for the other documents, that is, the document 2 of Embodiment 1, this setting is not necessary. Only performing operation steps for an ordinary printing, is enough.

Subsequently, according an application data put out from the application 30 (FIG. 1) to the printer driver 20 as a printing process means, how a printing data is made and a printing is performed, is described.

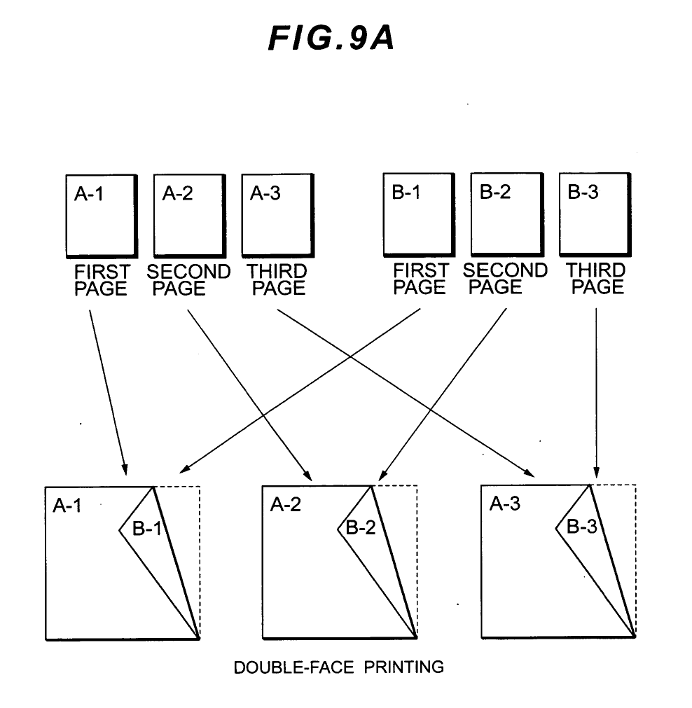

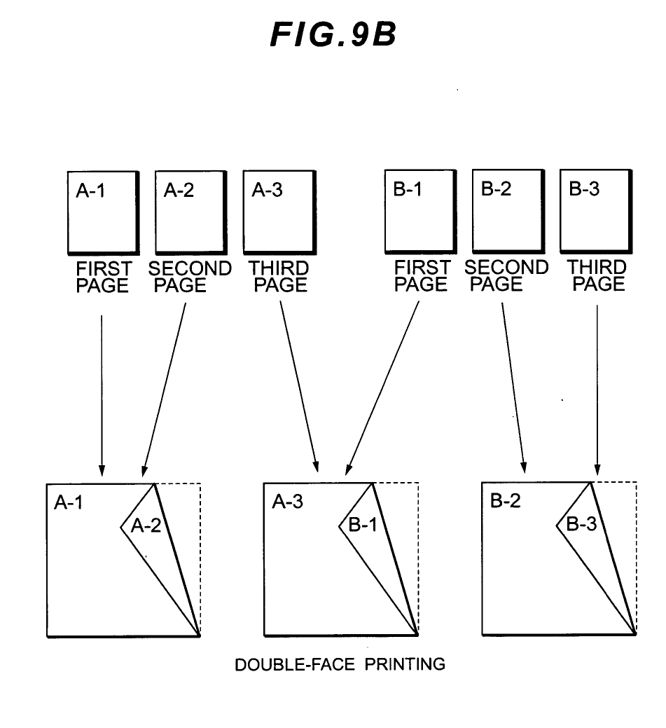

FIG. 9A is a diagram showing a concept of laying out printing data of Embodiment 2; FIG. 9B is a diagram showing another concept of laying out printing data of Embodiment 2.

In Embodiment 2, different application data of three pages are put out from a first application and a second application comprising the application 30 (FIG. 1). And, the printer driver 20 (FIG. 2) lays out, in Embodiment 2, two spool data to both faces of a same sheet.

First of all, a first page of the application data put out from the first application, is named A-1; a second page is named A-2; and a third page is named A-3. On the other hand, a first page of the application data put out from the first application, is named B-1; a second page is named B-2; and a third page is named B-3.

And, a spool data managing and laying out section 23, as a spool data managing and laying out process means and as a layout control section, performs a layout process. That is, referring to the management table 27, the spool data is laid to both faces of sheets. Then, a front face of a first printing page becomes A-1, a back face of a first printing page becomes B-1; a front face of a second printing page becomes A-2, a back face of a second printing page becomes B-2; and a front face of a third printing page becomes A-1, a back face of a third printing page becomes B-1. In this case, information of double-face printing is made from said layout information.

Succeedingly, the printing data making section 24, as a printing data making process means, makes a printing data according to the spool data laid out, so as to send it to the port controlling section 26, as a print data output process means. And, through the port controlling section 26, said printing data is sent to a printer 40. Then, a two-page printing is performed in the printer 40. In this case, each print content of A-1, B-1 is printed in each face of front and back of a first printing page, each print content of A-2, B-2 is printed in each face of front and back of a second printing page, and each print content of A-3, B-3 is printed in each face of front and back of a third printing page.

Subsequently, a printing process performed by said printer driver 20 is described.

In this case, as same as Embodiment 1, when a printing instruction is sent from the application 30, the spool data managing and laying out section 23 inquires of the layout setting section 22 whether a layout printing setting is performed or not. In case that a layout printing setting is not performed, the spool data managing and laying out section 23 starts a process about said spool data as this data is an ordinary print job. In case that a printing setting is performed, the spool data managing and laying out section 23 refers to a data table 28. And, it judges whether the document directed to be printed, is waiting for spooling or not.

On the other hand, in case that a printing setting is performed, the spool data managing and laying out section 23 refers to a data table 28. And, it judges whether the document directed to be printed, is not finished spooling, and is waiting for spooling or not.

And, in case that the document directed to be printed, is not waiting for spooling, and it is finished spooling; or in case that it is not a subject for spooling; it starts a process as an ordinary print job.

Moreover, in case that the document directed to be printed, is waiting for spooling, and it is not finished spooling; the spool data managing and laying out section 23 performs a spooling. Thereby, the spool data is contained in the shunting region 25, as a memory section. Then, a place where the spool data of said document, and a piece of information that said document is spooled; are contained and registered.

Subsequently, the spool data managing and laying out section 23 refers to the data table 28. Then, it judges whether spooling of all documents are finished or not. In case that spooling of all documents are finished; said layout process unit of the spool data managing and laying out section 23, reads all the spool data from the shunting region 25. Then, it lays the spool data laid in a layout on the layout printing setting screen.

Succeedingly, a subroutine of a layout process will be described.

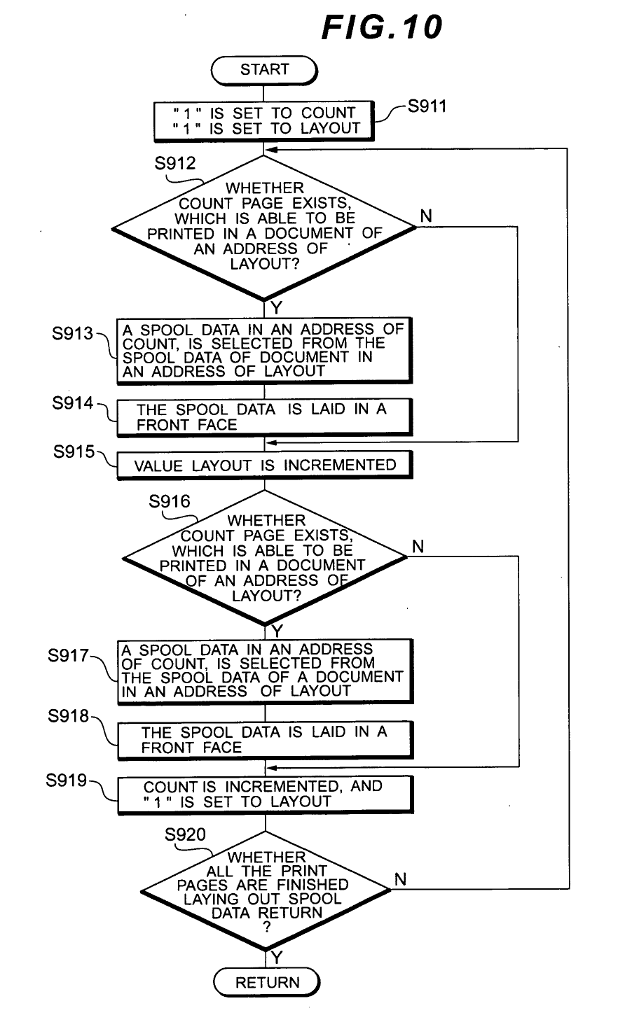

FIG. 10 is a flow chart showing a subroutine of laying out process of Embodiment 2.

In this case, the layout process unit edits a spool data read out from the shunting region 25 (FIG. 2) in a layout assigned in the layout printing setting screen as shown in FIG. 8 per each printing page.

For this purpose, Count value which represents page address of each document, is set to “1”. Layout value which represents document address of each document, is set to “1”.

And, the layout process unit judges whether Count page exists or not, which is able to be printed in a document of an address of Layout assigned in each layout (front face). In case that Count page does not exist, the layout process unit skips the process of the layout portion. The portion skipped is not printed by the printer 40 (FIG. 1).

Moreover, in case that Count page exists, the layout process unit selects a spool data in an address of Count of the corresponding page, from the spool data of a document in an address of Layout. And, it lays out the spool data selected, according to a layout assigned. Then, it lays out it in a place assigned by an address of Count, in Embodiment 2, in a front face.

And, the layout process unit increments a value of Layout. Then, the layout process unit judges whether Count page exists or not, which is able to be printed in a document of an address of Layout assigned in another layout (back face). In case that Count page does not exist, the layout process unit skips the process of the layout portion.

Moreover, in case that Count page exists, the layout process unit selects a spool data in an address of Count of the corresponding page, from the spool data of a document in an address of Layout. And, it lays out the spool data selected, according to a layout assigned. Then, it lays out it in a place assigned by an address of Count, in Embodiment 2, in a back face.

And, the layout process unit increments the value Count. And, it sets “1” to the value Layout. Then, it judges whether all the print pages are finished laying out spool data. In case that all the print pages are finished laying out spool data, the process ends.

Thus, in Embodiment 2, plural documents made independently by plural applications having different functions, are able to be printed laying in each face of front and back of a same sheet, by assigning each name of the documents in the printer driver 20. Therefore, for example, a document made by an application of a word processor, is laid in the front face of the layout. And, a table, a graph etc. made by an application of a graphic processor, is laid in the back face of the layout. Then, such a printing is able to be performed. As a result, waste of sheets can be prevented.

Succeedingly, a description will be performed referring to a flow chart.

STEP S911 “1” is set to value Count and value Layout.

STEP S912 Whether Count page exists or not, which is able to be printed in a document of an address of Layout, is judged. In case that Count page exists, the process proceeds to STEP S913. In case that Count page does not exist, the process proceeds to STEP S915.

STEP S913 A spool data in an address of Count of the corresponding page, is selected from the spool data of a document in an address of Layout.

STEP S914 The spool data is laid in a front face.

STEP S915 Value Layout is incremented.

STEP S916 Whether Count page exists or not, which is able to be printed in a document of an address of Layout, is judged. In case that Count page exists, the process proceeds to STEP S917. In case that Count page does not exist, the process proceeds to STEP S919.

STEP S917 A spool data in an address of Count of the corresponding page, is selected from the spool data of a document in an address of Layout.

STEP S918 The spool data is laid in a back face.

STEP S919 Value Count is incremented, and “1” is set to value Layout.

STEP S920 Whether all the print pages are finished laying out spool data or not, is judged. In case that all the print pages are finished laying out spool data, the process returns to the main routine. Otherwise, the process proceeds to STEP S912.

If Embodiment 2 is not used; and in case that a printing of front face and back face of a recording medium, is performed by using a conventional double-face printing function about a document of each three pages made by different applications; in a result of a printing of each document, blank of a face of a print medium occurs. Then, one page of a print medium as whole is wasted.

In the above Embodiment, as a layout method of two documents, an example of laying out each document assigned at front or back position of recording medium, is described. However, as shown in FIG. 9B, each of pages in a first document are laid in the front and back positions of a print medium in an order. Then, a layout method of laying out each page of a second document at front or back position succeedingly after finishing layout of a first document at front or back position, can be adopted. This method can similarly prevent from wasting recording media.

### Embodiment 3

Configuration

Subsequently, Embodiment 3 of the present invention which lays a desired page of a document made by a first application among plural applications 30, and a desired page of a document made by a second application among plural applications 30; in a desired same printing page; is described. Incidentally, elements having same configuration as Embodiment 1, is omitted by attaching same symbols. And, effects obtained by having same configuration as Embodiment 1, is omitted by referring to effects in Embodiment 1.

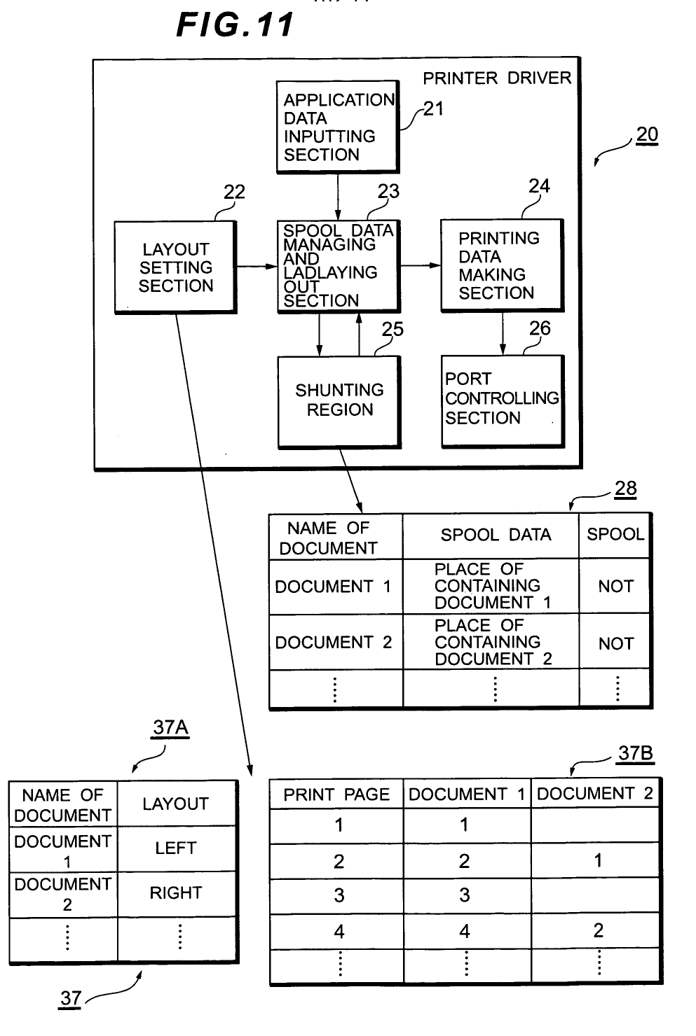

FIG. 11 is a block diagram showing a printer driver of Embodiment 3.

In this case, a setting information management table 27 comprises a first and a second tables 37A, 37B. A position of layout, for example, right or left etc. as layout information corresponding to document 1 is contained in a first table 37A. Moreover, a second table 37B functions as a print page information table, and print information per each print page 1, 2 is contained in the second table 37B. Which page of each document 1, 2 is assigned to which printing page of a final printing result, as corresponding information; is contained in the second table 37B.

Subsequently, an operation when a layout printing is performed by assigning to a same printing page, a desired page of a document made by a first application A and a desired page of a document made by a second application; is described.

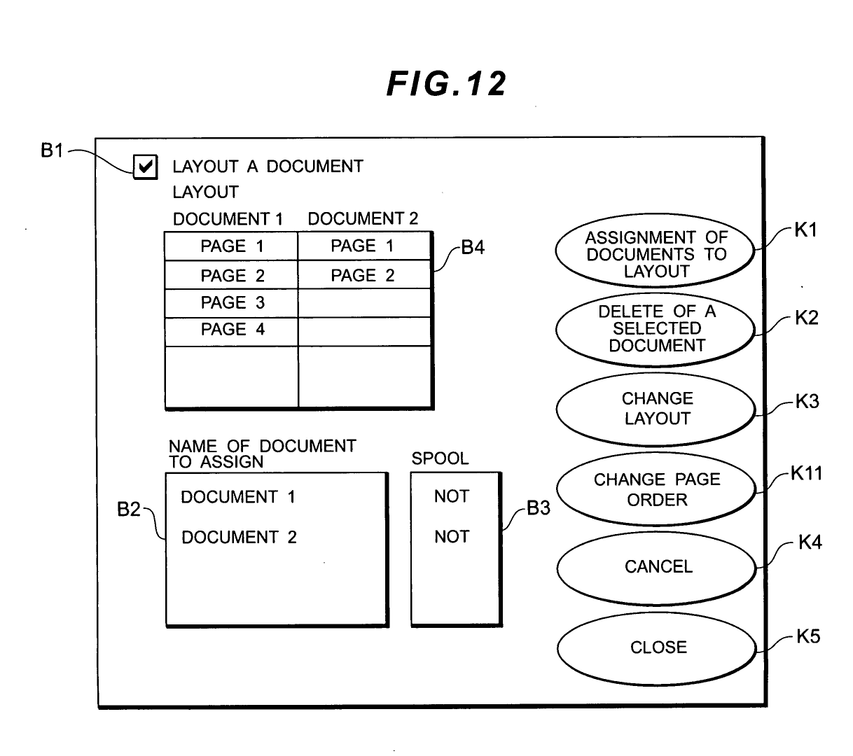

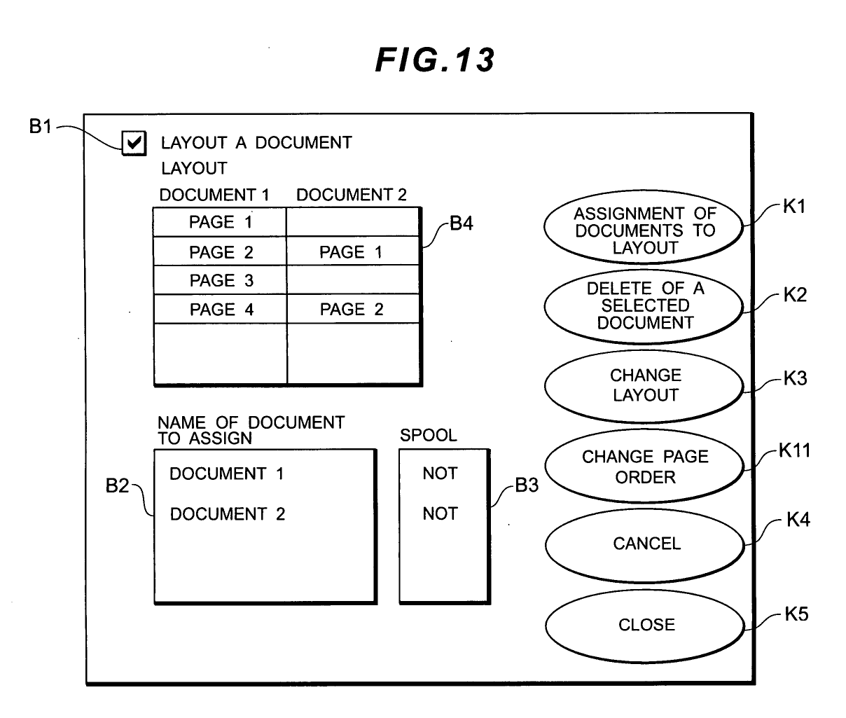

FIG. 12 is a diagram showing a presentation screen for laying out printing data of Embodiment 3; FIG. 13 is a diagram showing a presentation screen for laying out printing data when an order of pages are changed of Embodiment 3.

In Embodiment 2, an application 30 (FIG. 1) operates for editing a document file about a document 1. Incidentally, a layout printing setting screen can be selected from a property screen of a printer driver 20 as a printing process means presented when “print” menu is assigned from said application 30.

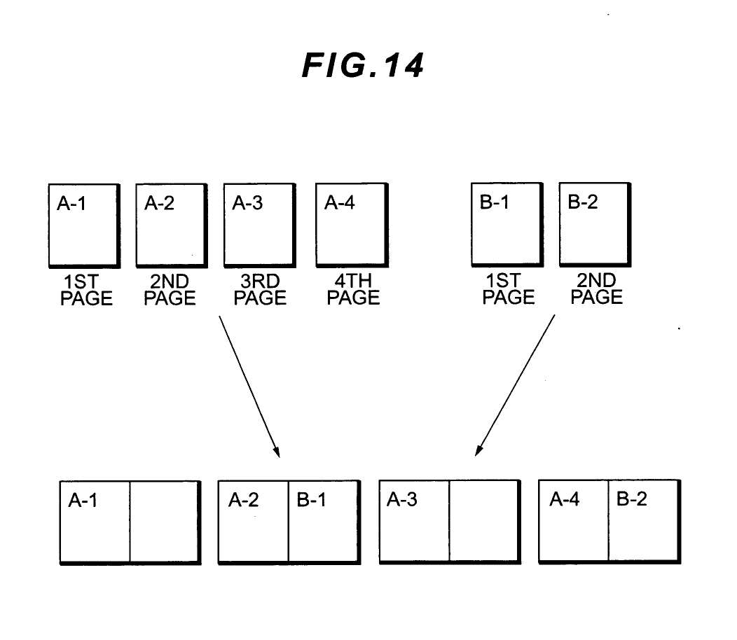

And, when an operator operates a keyboard as an inputting section, and checks a check box B1 to lay out a document on the layout printing setting screen shown in FIG. 3, as a presenting section; a function of multi-page printing is made effective. Then, in a list box B2 of “document names to lay out”, “document 1” is registered automatically. Incidentally, in Embodiment 3, as shown in FIG. 14, the document 1 includes application data Page 1 to Page 4 of four pages. These pages are set to be printed being laid in left side of each sheet in an order from the application Page 1 of the first page address. Moreover in the second table 37B, as an initial value, each page is laid in an order from the first page address.

Subsequently, when the operator clicks a button K1 “assignment of documents to lay out”, a selection screen of documents, is presented. Then, the other document to lay out, for example, in Embodiment 3, a document 2 is selected and assigned. As a result, documents laid out, that is, in Embodiment 3, documents 1 and 2 laid out, are presented in a box B4 of “layout”. Incidentally, a method of assigning, can be performed with using a selection screen which is proper to an operation system. Then, documents to select can be assigned on a layout printing setting screen, by using a method of “drag and drop”.

And, the assigned documents are added to the list box B2. Moreover, in Embodiment 3, the document 2 includes application data Page 1, Page 4 of two pages. These pages are set to be printed being laid in right side of each sheet in an order from the application Page 1 of the first page address.

And, in case that an operator wants to change the layout laid on the layout printing setting screen, the operator clicks a button K3 of “change layout”. Then, the layout laid in the box B4 is cleared. Moreover, the operator clicks a button K3 of “change layout”. Then, the order and layout position of application data of each document presented in the box B4; can be changed. (As for the document 1, the order and layout position of application data Page 1 to Page 4 can be changed. As for the document 2, the order and layout position of application data Page 1, Page 2 can be changed.)

In Embodiment 3, as shown in FIG. 13, the application data Page 1 of a first page address of document 2, is laid in a second printing page address of a final print result. And, the application data Page 2 of a second page address of document 2, is laid in a fourth printing page address of a final print result.

The above series of operation steps hereto, are enough, if they are performed only once at the beginning of the overall operation. And, as for the other documents, that is, the document 2 of Embodiment 1, this setting is not necessary. Only performing operation steps for an ordinary printing, is enough.

Subsequently, according an application data put out from the application 30 to the printer driver 20, how a printing data is made and a printing is performed, is described.

FIG. 14 is a diagram showing a presentation screen for laying out printing data of Embodiment 3.

In Embodiment 3, application data Page 1 to Page 4 of four pages are put out from a first application A; and application data Page 1, Page 2 of two pages are put out from a second application B. And, the printer driver 20 (FIG. 2) lays out each application data in a prescribed printing page.

First of all, a first page of the application data put out from the first application, is named A-1; a second page is named A-2; a third page is named A-3; and a fourth page is named A-4. On the other hand, a first page of the application data put out from the first application, is named B-1; and a second page is named B-2.

And, a spool data managing and laying out section 23 performs a layout process. That is, corresponding information is obtained from the management table 37, according to the corresponding information, the spool data is laid. A-1, A-2 etc. are laid in each left region of printing pages; and B-1, B-2 etc. are laid in each right region of printing pages. Here, A-1, A-3 in each left region is printed with blank.

Succeedingly, the printing data making section 24 makes a printing data according to the spool data laid out, so as to send it to the port controlling section 26. And, through the port controlling section 26, said printing data is sent to a printer 40. Then, a two-page printing is performed in the printer 40. In this case, each print content of A-1 is printed in a first printing page, each print content of A-2, B-1 is printed in a second printing page, each print content of A-3 is printed in a third printing page, and each print content of A-4, B-2 is printed in a fourth printing page.

Subsequently, a printing process performed by said printer driver 20 is described.

In this case, as same as Embodiment 1, when a printing instruction is sent from the application 30, the spool data managing and laying out section 23 inquires of the layout setting section 22 whether a layout printing setting is performed or not, about an application data of a document directed to be printed. In case that a layout printing setting is not performed, the spool data managing and laying out section 23 starts process letting a spool data to be an ordinary print job. In case that a printing setting is performed, the spool data managing and laying out section 23 refers to a data table 28. And, it judges whether the document directed to be printed, is not finished spooling, and is waiting for spooling or not.

And, in case that the document directed to be printed, is not waiting for spooling, and it is finished spooling; or in case that it is not a subject for spooling; it starts a process as an ordinary print job.

Moreover, in case that the document directed to be printed, is waiting for spooling, and it is not finished spooling; the spool data managing and laying out section 23 performs a spooling. Thereby, the spool data is contained in the shunting region 25. Then, a place where the spool data of said document, and a piece of information that said document is spooled; are contained and registered.

Subsequently, the spool data managing and laying out section 23 refers to the data table 28. Then, it judges whether spooling of all documents are finished or not. In case that spooling of all documents are finished; layout process unit not shown in the drawings of the spool data managing and laying out section 23, performs a layout process. That is, it read all the spool data from the shunting region 25. Then, it lays the spool data laid in a layout on the layout printing setting screen.

Succeedingly, a subroutine of a layout process will be described.

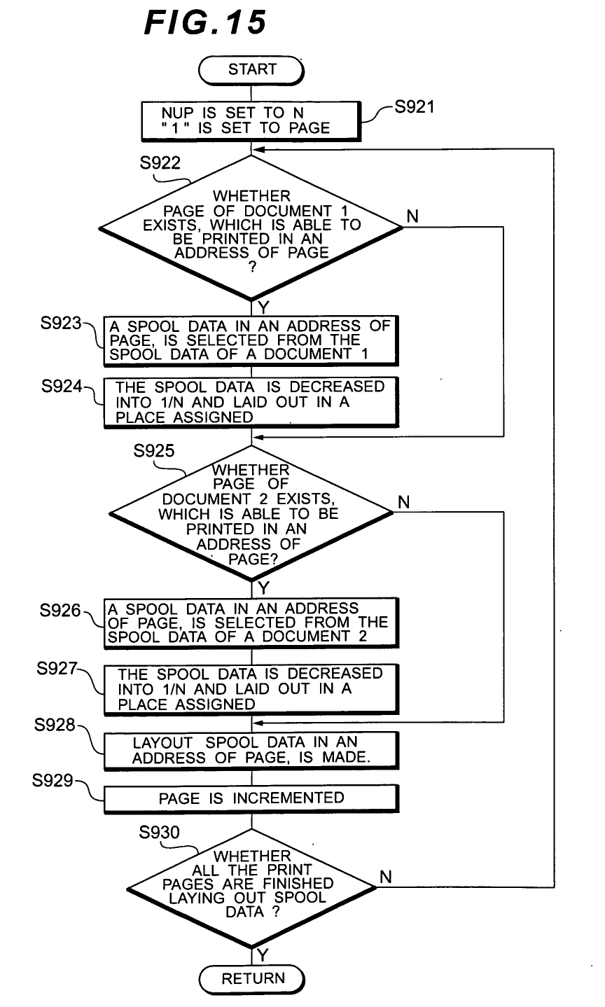

FIG. 15 is a diagram showing a concept of laying out printing data of Embodiment 3.

In this case, the layout process unit edits a spool data read out from the shunting region 25 in a layout assigned in the layout printing setting screen as shown in FIG. 14 per each printing page.

For this purpose, Nup number (“2” in Embodiment 1) which represents a number of documents laid in a same printing page, is set to a value N. Page value which represents page address of each printing page, is set to “1”.

And, the layout process unit refers to the second table 37B and judges whether the page of document 1 exists or not, which is able to be printed in the document 1 of an address of Page. In case that the page of document 1 does not exist, the layout process unit skips the process of the layout portion. The portion skipped is not printed by the printer 40.

Moreover, in case that the page of document 1 exists, which is able to be printed in a document of an address of Page, the layout process unit selects a spool data in an address of the corresponding Page, from the spool data of the document 1. And, it decreases the spool data selected, into a size of print region of a layout assigned (left side), that is, 1/N. Then, it lays out it in a place assigned by an address of Page.

Succeedingly, the layout process unit refers to the second table 37B and judges whether the page of document 2 exists or not, which is able to be printed in the document 2 of an address of Page. In case that the page of document 2 does not exist, the layout process unit skips the process of the layout portion. The portion skipped is not printed by the printer 40.

Moreover, in case that the page of document 2 exists, which is able to be printed in a document of an address of Page, the layout process unit selects a spool data in an address of the corresponding Page, from the spool data of the document 2. And, it decreases the spool data selected, into a size of print region of a layout assigned (right side), that is, 1/N. Then, it lays out it in a place assigned by an address of Page.

And, the layout process unit makes a spool data laid in the Page address. Then, it increments the value Page. Then, it judges whether all the print pages are finished laying out spool data. In case that all the print pages are finished laying out spool data, the process ends.

Thus, in Embodiment 3, plural documents made independently by plural applications having different functions, are able to be printed laying in a same printing page, by assigning each printing page in the printer driver 20. Therefore, for example, a document made by an application of a word processor, is laid in the left side of the printing page, corresponding to a desired printing page. And, a table, a graph etc. made by an application of a graphic processor, is laid in the right side of the printing page. Then, such a printing is able to be performed.

Succeedingly, a description will be performed referring to a flow chart.

STEP S921 Nup number is set to value N. “1” is set to value Page.

STEP S922 Whether page of document 1 exists or not, which is able to be printed in a document of an address of Page, is judged. In case that page of document 1 exists, the process proceeds to STEP S923. In case that page of document 1 does not exist, the process proceeds to STEP S925.

STEP S923 A spool data in an address of Page, is selected from the spool data of a document 1.

STEP S924 The spool data is decreased into 1/N. Then, it lays out it in a place assigned.

STEP S925 Whether page of document 2 exists or not, which is able to be printed in a document of an address of Page, is judged. In case that page of document 2 exists, the process proceeds to STEP S926. In case that page of document 2 does not exist, the process proceeds to STEP S928.

STEP S926 A spool data in an address of Page, is selected from the spool data of a document 2.

STEP S927 The spool data is decreased into 1/N. Then, it lays out it in a place assigned.

STEP S928 A spool data of a printing page laid in the Page address, is made.

STEP S929 Value Page is incremented.

STEP S930 Whether all the print pages are finished laying out spool data or not, is judged. In case that all the print pages are finished laying out spool data, the process returns to the main routine. Otherwise, the process proceeds to STEP S922.

### Other Embodiments

Although, in Embodiment 1 to 3, each layout process for laying out an application data 30, is performed on a client computer 10, as an example; it can be performed on a printer server or on a control section of a printer 40.

Moreover, a printing data made by a printer driver 20, can be a bit map image data other than PDL etc. of PostScript etc.

Incidentally, the present invention is not limited to these embodiments, and it can be applied to various modified embodiments, which are not excluded from a scope of the present invention.

1. An image processing apparatus comprising:
a memory section for containing plural printing data made by plural applications,
an input section for inputting information of laying out said printing data, an analyzing section for analyzing said information of laying out said printing data, and
a laying out control section for reading out said printing data from said memory section and for laying out said printing data on a recording medium.

2. An image processing apparatus according the claim 1 wherein said laying out control section lays each printing data in plural divided regions in case that layout information is information of a multi-page printing.

3. An image processing apparatus according the claim 1 wherein said laying out control section lays each printing data in a first and a second faces in case that layout information is information of a duplex printing.

4. An image processing apparatus according the claim 1 wherein said laying out control section lays each printing data based on information of correspondence between each of printing data, after obtaining said information of correspondence included in said layout information.

5. A data editing method comprising a steps of:
containing plural printing data made by plural applications in a memory section,
inputting information of laying out said printing data with an input section,
analyzing said information of laying out said printing data with an analyzing section, reading out said printing data from said memory section, and
laying out said printing data on a recording medium with a laying out control section.

6. A data editing method according the claim 5 wherein said step of laying out is performed by laying out each printing data in plural divided regions in case that layout information is information of a multi-page printing.

7. A data editing method according the claim 5 wherein said step of laying out is performed by laying out each printing data in a first and a second faces in case that layout information is information of a duplex printing.

8. A data editing method according the claim 5 wherein said step of laying out is performed by each printing data based on information of correspondence between each of printing data, after obtaining said information of correspondence included in said layout information.
